(19) United States
(12) Patent Application Publication
(10) Pub. No.: US 2025/0068736 A1
(43) Pub. Date: Feb. 27, 2025

(54) ZERO DWELL TIME PROCESS MONITORING

(71) Applicant: Virsec Systems, Inc., San Jose, CA (US)

(72) Inventors: Satya V. Gupta, Dublin, CA (US); Joel Estibeiro, Iblur Village (IN)

(21) Appl. No.: 18/724,306

(22) PCT Filed: Jan. 10, 2023
(86) PCT No.: PCT/US2023/060374

§ 371 Date: Jun. 26, 2024

Related U.S. Application Data
(60) Provisional application No. 63/269,047, filed on Mar. 9, 2022.

(30) Foreign Application Priority Data
Jan. 10, 2022 (IN) 202241001242

(51) Int. Cl. G06F 21/56; G06F 21/55

(52) U.S. Cl. CPC G06F 21/566; G06F 21/554

(57) ABSTRACT

Embodiments provide process monitoring. One such embodiment begins by receiving a system call associated with a process. In turn, in a modified system call table of an operating system, such an embodiment identifies (i) a modified handler corresponding to the received system call and (ii) an original handler corresponding to the received system call. Next, in parallel, validity of the process is analyzed using the modified handler and the system call and the system call is serviced using the original handler. The servicing of the system call is maintained or stopped based on the analyzing.

### RELATED APPLICATIONS

This application claims the benefit of U.S. Provisional Application No. 63/269,047, filed on Mar. 9, 2022.

The Application claims priority under 35 U.S.C. § 119 or 365 to India application No. 202241001242, filed Jan. 10, 2022.

The entire teachings of the above Applications are incorporated herein by reference.

### BACKGROUND

With each passing day, cyber-attacks are becoming increasingly sophisticated. Attacks are often targeted to exploit specific vulnerabilities in specific programs, processes, and applications. Various methods and tools exist for protecting against these attacks, however these existing methods and tools are inadequate.

### SUMMARY

Embodiments provide systems, methods, and computer program products to monitor programs, processes, and applications.

An example embodiment is directed to a method for monitoring a process. The method receives a system call associated with a process. In turn, in a modified system call table of an operating system, a modified handler corresponding to the received system call is identified and an original handler corresponding to the received system call is identified. In parallel, validity of the process is analyzed using the modified handler and the system call and the system call is serviced using the original handler. In turn, servicing of the system call is maintained or stopped based on the analyzing.

In an embodiment, the received system call is: clone, fork, vfork, execve, or execveat.

Embodiments may further create the modified system call table. According to an embodiment, creating the modified system call table comprises for at least one system call in an original system call table of the operating system, adding an association, in memory, between a respective modified handler and the at least one system call.

In an embodiment, the system call comprises at least one of: a filename, a command line argument, and a variable value. In such an embodiment, analyzing validity of the process using the modified handler and the system call comprises determining validity of at least one of: the filename, the command line argument, and the variable value.

According to another embodiment, maintaining or stopping servicing of the system call based on the analyzing includes, responsive to the analyzing determining the process is valid, maintaining servicing of the system call and, responsive to the analyzing determining the process is invalid, implementing a protection action. In an embodiment, the protection action includes terminating the process.

Another example embodiment is directed to a computer system. The computer system includes a processor and a memory with computer code instructions stored thereon. In such an embodiment, the processor and the memory, with the computer code instructions, are configured to cause the system to implement any embodiment or combination of embodiments described herein.

Yet another embodiment is directed to a computer program product. The computer program product comprises one or more non-transitory computer-readable storage devices and program instructions stored on at least one of the one or more storage devices. The program instructions, when loaded and executed by a processor, cause an apparatus associated with the processor to implement any embodiment or combination of embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flow diagram of a method for monitoring a process according to an embodiment.

FIG. 2 is a simplified diagram of a system for monitoring a process according to an example embodiment.

FIG. 3 illustrates a computer network or similar digital processing environment in which embodiments may be implemented.

FIG. 4 is a diagram illustrating an example internal structure of a computer in the environment of FIG. 3.

### DETAILED DESCRIPTION

A description of example embodiments follows. Embodiments provide improved functionality to monitor computer processes.

A problem faced by modern security solutions when attempting to prevent attacks is the latency between (i) the exploitation of a system and (ii) the detection of the attack by the underlying solution. An attacker can run an extremely malicious process (e.g., ransomware) within milliseconds of obtaining access to a vulnerable machine. Even as security solution response times improve, it is very nearly impossible to stop a determined attacker from running a malicious process once the attacker has obtained access to the machine.

Modern security solutions need to stop the attacker before the malicious process can begin execution, i.e., a Zero Dwell Time solution is needed. That is where embodiments, which may be referred to herein as the “Process Monitoring Engine,” come in. Specifically, embodiments provide functionality where a malicious process is identified and stopped before it can begin execution. Hence, stopping the attacker from running malicious code.

Attempts have been made to provide zero dwell time, or near zero dwell time protection, but the existing solutions are inadequate.

### Kprobes

One such existing solution are kprobes. Kprobes enable installing pre-handlers and post-handlers for any kernel instruction as well as for function-entry and function-return handlers. Handlers get access to registers and can alter the registers. This way, functionality could possibly get a chance to both monitor the work process and alter the work process. System Tap is an example of a dynamic instrumentation tool for the Linux kernel that internally uses kprobes by default.

Kprobes is only a tool for setting a breakpoint at a particular place in the kernel. To get function arguments or local variable values, knowledge as to where exactly on the stack and in what registers the function arguments or local variable values are located is needed.

Even though it is a one-time procedure, positioning breakpoints is quite costly. While breakpoints do not affect the rest of the functions, processing breakpoints is also relatively expensive. Fortunately, the costs of using kprobes can be reduced significantly by using a jump-optimization implemented for the x86_64 architecture. Still, the cost of kprobes surpasses that of modifying the system call table (as implemented by embodiments).

Kprobes is based on interruptions and fiddles with the processor registers. As such, in order to perform synchronization, all handlers need to be executed with a disabled preemption. As a result, there are several restrictions for the handlers: existing methods cannot wait in the handlers, meaning such methods cannot allocate large amounts of memory, deal with input-output, and sleep in semaphores and timers, amongst other examples.

### Extended Berkeley Packet Filter

eBPF facilitates running sandboxed programs within an operating system, which enables application developers to run eBPF programs to add additional capabilities to the operating system at runtime. The operating system then guarantees safety and execution efficiency as if natively compiled with the aid of a Just-In-Time (JIT) compiler and verification engine. System Tap itself has an option to insert custom code using an eBPF backend.

However, eBPF has limitations. The biggest limitation of eBPF is that it is restricted to recent versions of the Linux kernel. Making full use of eBPF requires a kernel version of 4.4 and above. This makes it difficult to implement in older Linux distributions that are still in use. Further, the size of an eBPF program is limited to a maximum of 4096 bytes, which ensures the program terminates without an unbounded loop. This also limits the resources a program can have access to, and the functionality that can be implemented with the programs. Therefore, eBPF programs tend to be very small.

As such, existing functionality, such as kprobes and eBPF, are inadequate solutions for providing zero dwell time process monitoring. Embodiments solve these problems and provide improved functionality to monitor systems and processes.

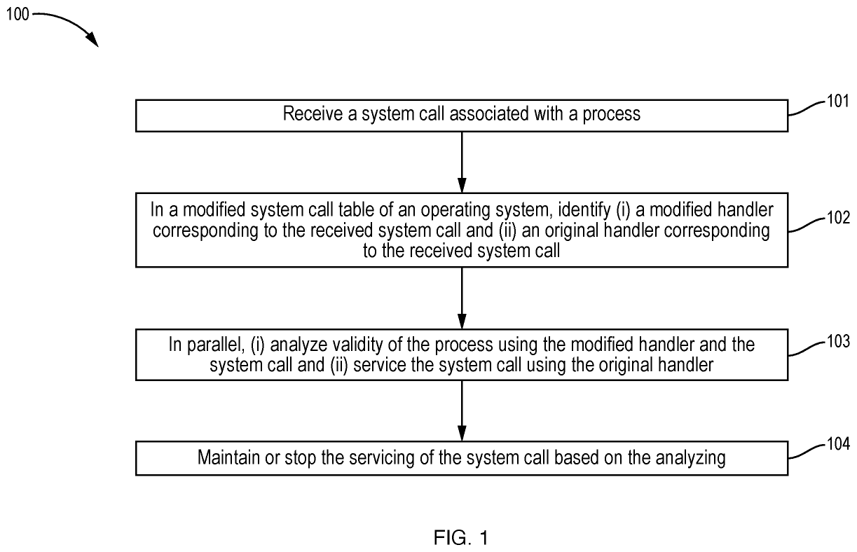

FIG. 1 is a flowchart of an example method 100 embodiment. The method 100 begins at step 101 by receiving a system call associated with a process. In turn, at step 102, in a modified system call table of an operating system, a modified handler corresponding to the received system call is identified and an original handler corresponding to the received system call is identified. In parallel, at step 103, validity of the process is analyzed using the modified handler and the system call, and the system call is serviced using the original handler. In turn, at step 104, servicing of the system call is maintained or stopped based on the analyzing.

In an embodiment, the system call received at step 101 is: clone, fork, vfork, execve, or execveat. Moreover, it is noted that while embodiments are described herein in relation to a Linux operating system, embodiments are not limited to Linux operating systems and may be implemented in any operating systems that utilize a system call table.

Embodiments of the method 100 may further create the modified system call table. According to such an embodiment of the method 100, creating the modified system call table comprises for at least one system call in an original system call table of the operating system, adding an association, in memory, between a respective modified handler and the at least one system call. An embodiment creates the modified system call table by creating a “jump” table that causes trampolining from the original system call to the “modified” call and back to the original system call.

In an embodiment of the method 100, the system call comprises at least one of: a filename, a command line argument, and a variable value. In such an embodiment, analyzing validity of the process using the modified handler and the system call at step 103 comprises determining validity of at least one of: the filename, the command line argument, and the variable value. An example embodiment validates provenance of the file indicated by the filename. When it comes to command strings, an embodiment ensures that an end-user has not supplied a command string that appears in a child process's command line. If it does, then such an embodiment concludes an attacker has been able to influence the outcome.

According to another embodiment of the method 100, maintaining or stopping servicing of the system call based on the analyzing at step 104 includes, responsive to the analyzing (103) determining the process is valid, maintaining servicing (103) of the system call and, responsive to the analyzing determining the process is invalid, implementing a protection action. In an embodiment, the protection action includes any such protection action that is desired. For instance, in an embodiment the protection action terminates the process.

In most operating systems, the interface between a process and an operating system (OS) is provided by system calls. System calls are usually made when a process in user mode requires access to a resource. Then, the process requests the kernel to provide the resource via a system call. When considering the process of executing a program, the user mode application is requesting the kernel for the resources and permissions to execute said program. A malicious attacker in control of the user mode, also has to use these system calls to execute the attacker's own malicious program since process creation is handled by the OS.

Embodiments leverage an attacker's reliance on system calls to provide process monitoring. An example embodiment, operating in a Linux OS, performs process verification/monitoring pursuant to one or more system calls from a family of system calls. In such an embodiment, the family of system calls, are system calls related to process creation, such as, clone, fork, vfork, execve, execveat. To create a new process, any one of the foregoing system calls is used. Embodiments instrument these system calls before the request reaches the kernel, so as to analyze the process and terminate the process before the process can cause any data damage. This is done using the system call table.

### System Call Table

Whenever a distribution, e.g., a Linux distribution, boots up, a system call table is loaded into the kernel memory. The system call table is essentially a table of function pointers that guides an incoming system call from the user space to the appropriate kernel function that will handle the system call. For example, if a process were to use the ‘read’ system call from the user space, the kernel would call the function corresponding to the ‘read’ system call i.e., the ‘sys_read’ function.

### Hijacking the System Call Table

Embodiments, e.g., the method 100, monitor processes by hijacking, i.e., modifying, the system call table. An embodiment, first, finds the address of the system call table using the “kallsyms_lookup_name” function. After finding the address of the system call table, such an embodiment arranges the pointers in the system call table according to system call numbers defined in the “linux/syscalls.h” header file. Embodiments then overwrite the system call table with desired functions to enable intercepting any desired system call.

### Intercepting Process Creation

Through the aforementioned system call table hijacking, embodiments can intercept any system call from the user space. Once the system call is intercepted, embodiments can check validity of the process requesting the system call.

Rather than intercepting every system call, an embodiment intercepts systems calls that are associated with process creation, such as the ‘execve’ system call. In such an embodiment, when an ‘execve’ system call is made, the ‘execve’ system call is intercepted and, responsively, an embodiment analyzes the process that made the ‘execve’ system call.

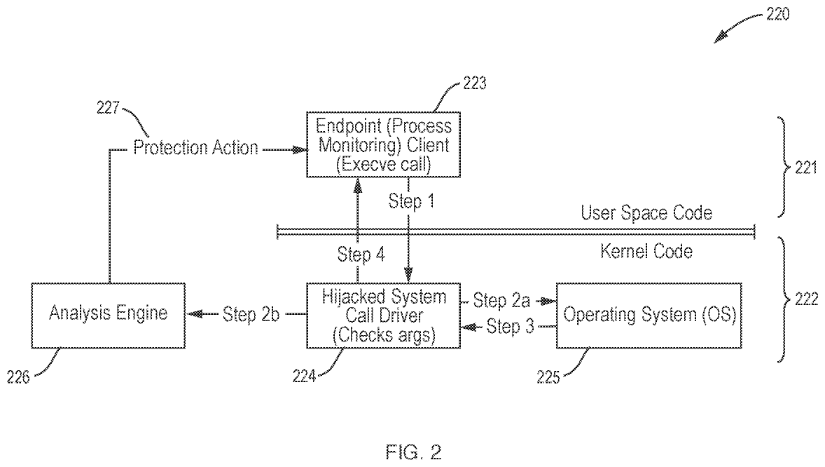

FIG. 2 is a block diagram of a system 220 that illustrates such an embodiment. In particular, the system 220 illustrated in FIG. 2 can be used to implement zero-dwell time process monitoring according to an embodiment.

The system 220 includes user space code 221 and kernel code 222. The user space code 221 includes an endpoint client 223 and the kernel code 222 includes a hijacked system call driver 224, operating system 225, and analysis engine 226. According to an embodiment, shared memory is used by both the analysis engine 226 and user space code 221.

In a non-limiting illustrative embodiment of the system 220, at step 1, the endpoint client 223 sends an ‘execve’ system call to the kernel 222. According to an embodiment, the ‘execve’ system call takes three arguments: filename, i.e., executable code (to be executed), command line arguments, and environment variables. The ‘execve’ system call is intercepted at the hijacked system call driver 224. At this stage, such an embodiment proceeds to two parallel steps, namely, step 2a and step 2b. Step 2a sends the system call to the operating system 225, as in accordance with standard procedures for responding to system calls. Specifically, the original function, corresponding to execve, is called with the original arguments. The operating system 225, at step 3, provides the requested resources to the system call driver 224. Meanwhile (in parallel with the functionality of step 2a), at step 2b, the hijacked system call driver 224 calls a custom function in a kernel module. This custom function is called as a result of the system call table hijacking where the custom function is stored or otherwise pointed to through a mapping between the execve system call and the custom function. The custom function is implemented by the analysis engine 226 and takes the filename and the arguments, from the execve system call, and checks the integrity of the code to be executed, e.g., as indicated by the filename and arguments. As such, the system 220 is proceeding in two parallel paths, a traditional path (steps 2a and 3) for responding to a system call and a path (step 2b) for determining integrity of the code to be executed.

Based on the results of the analysis implemented by the analysis engine 226, the system 220 will either proceed with providing resources to the endpoint 223 at step 4, where the provided resources are the result of normal execution (steps 2a and 3), or the system 220 will take some protection action 227. This protection action may include terminating the process 223 and exiting.

### Implementation and Example Results

What follows is a description of an example implementation and results achieved using said implementation.

The example implementation utilized a hijacked system call table, as described herein, and the decision to suspend the process was made by a concurrently running user space application. Memory was shared between the kernel module and the user space application by the use of the “mmap” system call and mapping the memory allocated by the kernel module in the address space of the user space application. Data was shared in this memory by use of circular buffers.

Running through an entire flow of the implementation, according to an embodiment, an incoming or outgoing system call was intercepted, and the data was stored in a “syscall” object and added to the “system call ring buffer”. This thread then waits for a decision to be made. The user space application that is running concurrently notices this entry and tries to process the entry. The user space application analyzes the system call data (arguments and return value) and the past system call data of the calling thread and decides on whether it should kill the thread or let it go. This decision is then stored in a “response” object and added to the “response ring buffer”. A separate kernel thread then picks this response up and, depending on what the response is, either lets the calling thread proceed or terminates the thread.

To analyze the impact of the kernel module and its cost efficiency, some benchmark tests were run with and without the kernel module. A simple benchmark was used for this driver, considering only the execve system call. The benchmark runs 5 processes concurrently that each call execve in a loop for 10\hat{ }6 times. So, the total number of execve system calls made would be 5×10\hat{ }6 calls. The benchmark testing used perf to obtain the cpu-clocks consumed by the benchmark and noted the following results:

TABLE 1

| | Cpu-clocks (w/o | Cpu-clocks (with | |
|---|---|---|---|
| Run | driver) | driver) | Percentage diff |
| 1 | 2845864.827174 | 2866142.521824 | 0.71% |
| | (775.5 secs) | (782.53 secs) | |
| 2 | 2845864.827174 | 2866277.179347 | 0.717% |
| | (775.5 secs) | (784.01 secs) | |
| 3 | 2845864.827174 | 2870761.155960 | 0.87% |
| | (775.5 secs) | (785.32 secs) | |
| 4 | 2845864.827174 | 2888152.345716 | 1.48% |
| | (775.5 secs) | (789.09 secs) | |

As can be observed in Table 1, the percentage difference caused by using embodiments (i.e., with a hijacked system call driver) is very small. As such, embodiments have a very small impact on the consumption of CPU resources and there is space for inclusion of additional code, if necessary.

Since embodiments are inserting code into the system call path, another statistic that illustrates the impact of embodiments is the time it takes to complete the system call with the driver. Table 2 below shows the time it takes without the driver, i.e., without embodiments described herein, and Table 3 below shows the time it takes with the system call driver, i.e., using embodiments described herein:

TABLE 2
Without Embodiments

| Run | μsecs/call |
|---|---|
| 1 | 221 |
| 2 | 224 |
| 3 | 235 |
| 4 | 233 |
| Avg | 228.25 |

TABLE 3
With Embodiments

| Run | μsecs/call |
|---|---|
| 1 | 263 |
| 2 | 228 |
| 3 | 229 |
| 4 | 239 |
| Avg | 239.75 |

Tables 2 and 3 show that embodiments have a slight impact on the time it takes to complete a system call, but this impact is well within acceptable limits.

Embodiments provide significant advantages over existing methods. By hijacking the system call table, embodiments are able to obtain (and store for further analysis) the arguments and return value of every system call that is being traced. In an embodiment, code, e.g., code of the analysis engine 226 and/or endpoint 223, runs with preemption enabled which enables embodiments to use semaphores, allocate huge chunks of memory, deal with input-output to make the code more dynamic, and protect critical sections.

Moreover, modifying the system call table is extremely cost efficient and embodiments can be applied to old and new versions of the Linux kernel. Further, since embodiments are overwriting the system call table itself, there is no restriction on the size of the injected code. In addition, the decision making is done within the kernel itself and, as such, the need for context switching and/or waiting for a response from the user space is avoided.

### Computer Support

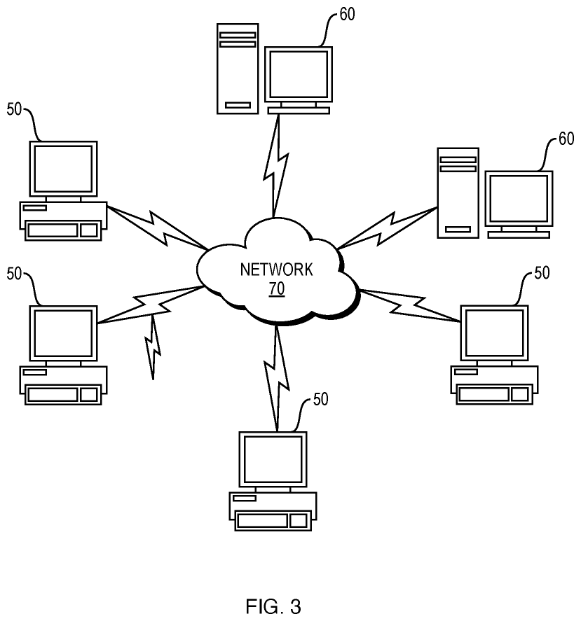

FIG. 3 illustrates a computer network or similar digital processing environment in which embodiments of the present disclosure may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

Client computers/devices 50 and/or servers 60 may be configured, alone or in combination, to implement the embodiments described herein, e.g., the method 100, amongst other examples. The server computers 60 may not be separate server computers but part of cloud network 70.

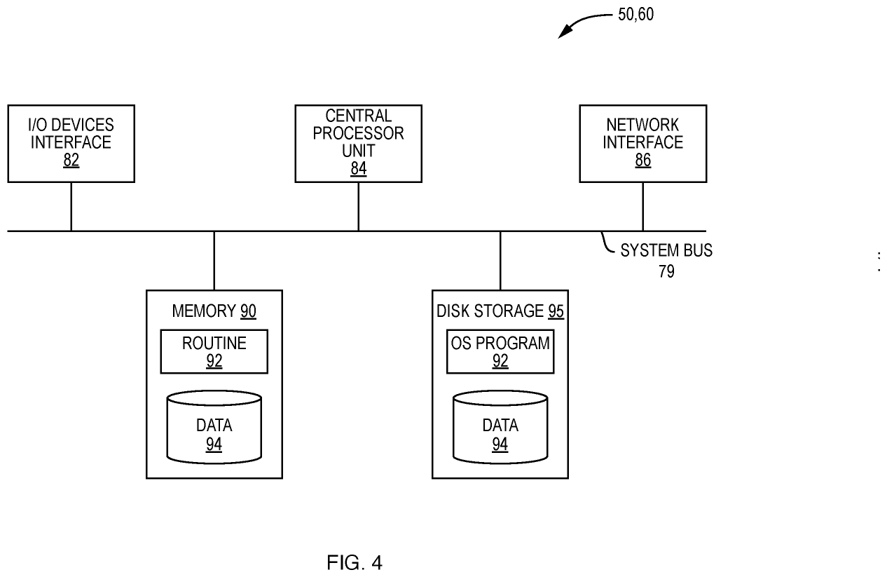

FIG. 4 is a diagram of an example internal structure of a computer (e.g., client processor/device 50 or server computers 60) in the computer system of FIG. 3. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an input/output (I/O) device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 3). Memory 90 provides volatile storage for computer software instructions 92 and data 94 used to implement an embodiment of the present disclosure (e.g., the method 100, amongst others). Disk storage 95 provides non-volatile storage for computer software instructions 92 and data 94 used to implement an embodiment of the present disclosure. A central processor unit 84 is also attached to the system bus 79 and provides for the execution of computer instructions.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method for monitoring a process, the method comprising:
receiving a system call associated with a process;
in a modified system call table of an operating system, identifying (i) a modified handler corresponding to the received system call and (ii) an original handler corresponding to the received system call;
in parallel, (i) analyzing validity of the process using the modified handler and the system call and (ii) servicing the system call using the original handler; and
maintaining or stopping the servicing of the system call based on the analyzing.

2. The method of claim 1 wherein the received system call is: clone, fork, vfork, execve, or execveat.

3. The method of claim 1 further comprising:
creating the modified system call table.

4. The method of claim 3 wherein creating the modified system call table comprises:
for at least one system call in an original system call table of the operating system, adding an association, in memory, between a respective modified handler and the at least one system call.

5. The method of claim 1 wherein the system call comprises at least one of: a filename, a command line argument, and a variable value.

6. The method of claim 5 wherein analyzing validity of the process using the modified handler and the system call comprises:
determining validity of at least one of: the filename, the command line argument, and the variable value.

7. The method claim 1 wherein maintaining or stopping servicing of the system call based on the analyzing comprises:
responsive to the analyzing determining the process is valid, maintaining servicing of the system call; and
responsive to the analyzing determining the process is invalid, implementing a protection action.

8. The method of claim 7 wherein the protection action is terminating the process.

9. A system comprising:
a processor; and
a memory with computer code instructions stored thereon, the processor and the memory, with the computer code instructions, being configured to cause the system to:
receive a system call associated with a process;
in a modified system call table of an operating system, identify (i) a modified handler corresponding to the received system call and (ii) an original handler corresponding to the received system call;
in parallel, (i) analyze validity of the process using the modified handler and the system call and (ii) service the system call using the original handler; and
maintain or stop the servicing of the system call based on the analyzing.

10. The system of claim 9 wherein the received system call is: clone, fork, vfork, execve, or execveat.

11. The system of claim 9 wherein the processor and the memory, with the computer code instructions, are further configured to cause the system to:
create the modified system call table.

12. The system of claim 11 wherein, in creating the modified system call table, the processor and the memory, with the computer code instructions, are configured to cause the system to:
for at least one system call in an original system call table of the operating system, add an association, in memory, between a respective modified handler and the at least one system call.

13. The system of claim 9 wherein the system call comprises at least one of: a filename, a command line argument, and a variable value.

14. The system of claim 13 wherein, in analyzing validity of the process using the modified handler and the system call, the processor and the memory, with the computer code instructions, are configured to cause the system to:
determine validity of at least one of: the filename, the command line argument, and the variable value.

15. The system of claim 9 wherein, in maintaining or stopping servicing of the system call based on the analyzing, the processor and the memory, with the computer code instructions, are configured to cause the system to:
responsive to the analyzing determining the process is valid, maintain servicing of the system call; and
responsive to the analyzing determining the process is invalid, implement a protection action.

16. The system of claim 15 wherein the protection action is terminating the process.

17. A computer program product comprising:
one or more non-transitory computer readable storage devices and program instructions stored on at least one of the one or more storage devices, the program instructions, when loaded and executed by a processor, cause an apparatus associated with the processor to:
receive a system call associated with a process;
in a modified system call table of an operating system, identify (i) a modified handler corresponding to the received system call and (ii) an original handler corresponding to the received system call;
in parallel, (i) analyze validity of the process using the modified handler and the system call and (ii) service the system call using the original handler; and
maintain or stop the servicing of the system call based on the analyzing.

18. The computer program product of claim 17 wherein the program instructions, when loaded and executed by the processor, cause the apparatus associated with the processor to:
create the modified system call table by, for at least one system call in an original system call table of the operating system, adding an association, in memory, between a respective modified handler and the at least one system call.

19. The computer program product of claim 17 wherein, in analyzing validity of the process using the modified handler and the system call, the program instructions, when loaded and executed by the processor, cause the apparatus associated with the processor to:
determine validity of at least one of: the filename, the command line argument, and the variable value.

20. The computer program product of claim 17 wherein, in maintaining or stopping servicing of the system call based on the analyzing, the program instructions, when loaded and executed by the processor, cause the apparatus associated with the processor to:
responsive to the analyzing determining the process is valid, maintain servicing of the system call; and
responsive to the analyzing determining the process is invalid, implement a protection action.
